(19) United States
(12) Patent Application Publication
(10) Pub. No.: US 2008/0308298 A1
(43) Pub. Date: Dec. 18, 2008

(54) Electrical Switching Device, in Particular High-Voltage Circuit Breaker, with a Housing

(75) Inventor: Frank Reincke, Berlin (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munich (DE)

(21) Appl. No.: 12/097,673

(22) PCT Filed: Dec. 12, 2006
(86) PCT No.: PCT/EP06/69577

§ 371 Date: Jun. 16, 2008

(30) Foreign Application Priority Data
Dec. 16, 2005 (DE) 10 2005 060 908.2

(51) Int. Cl. H01B 17/42

(52) U.S. Cl. 174/140 R

(57) ABSTRACT

An electric switchgear has a housing which surrounds an interrupter unit. Post insulators are provided so as to support the interrupter unit in an insulated manner. The post insulators are fitted with a capacitive coating which homogenizes the voltage distribution along the post insulators. Additionally, the capacitive coatings can be used to dampen a traveling voltage wave incoming during an interruption of a short-line fault and thus increase the short-circuit breaking capacity of the electric switchgear.

The invention relates to an electrical switching device, in particular a high-voltage circuit breaker, with a housing and an interrupter unit, which is surrounded by the housing, and with at least one post insulator for supporting the interrupter unit in electrically insulated fashion on the housing.

Such an electrical switching device is known, for example, from the laid-open specification DE 44 18 797 A1. This document describes an electrical switching device in the form of a high-voltage circuit breaker which has an interrupter unit. The interrupter unit is used for producing an electrically conducting connection or for breaking such a connection. The interrupter unit is arranged within a housing and is supported in electrically insulated fashion on the housing by means of a post insulator.

In particular when using electrical switching devices in the high-voltage and extra-high-voltage ranges, i.e. at voltages of above 1000 volts, increased electrical fields may occur. The reason for this is that large potential differences need to be isolated from one another along distances which are as short as possible. In order to be able to withstand permanent loading by the high electrical fields over years, known post insulators are dimensioned so as to have a correspondingly large volume. A post insulator firstly needs to take on the electrically insulating function and secondly needs to ensure the mechanical support of an interrupter unit. For these tasks, qualitatively high-grade insulating materials need to be used which, owing to the required quality, are correspondingly cost-intensive and involve complex manufacturing processes.

The object of the invention is therefore to configure an electrical switching device of the type mentioned at the outset in such a way that the post insulator withstands dielectric loading to an improved extent.

According to the invention, this is achieved in the case of an electrical switching device of the type mentioned at the outset by virtue of the fact that the post insulator has a controlling capacitance layer.

Dielectric loading of the post insulator is firstly dependent on the magnitude of the electrical potentials to be isolated and the length of the potential isolation path. Secondly, the loading is dependent on how the change in potential on the post insulator is represented. In unfavorable cases it is possible for there to be a voltage distribution along the post insulator which has high potential differences over short sections and only low potential differences over longer sections. This results in a nonuniform voltage distribution on the post insulator. In the region of high potential differences over short sections, the insulating material is subject to increased stress. The overall construction of the post insulator should be designed for such extreme ranges. As a result, it is necessary to use post insulators which are designed to be correspondingly large and are apparently overdimensioned or else to use correspondingly high-grade insulating materials.

As a result of a configuration according to the invention of post insulators on electrical switching devices with a controlling capacitance layer, the voltage distribution on the post insulator can be made more uniform, i.e. the insulating path of the post insulator will have to isolate an approximately identical potential difference on different path sections. The capacitance layer is therefore used for controlling an electrical field. As a result, unfavorable peak loadings are avoided. For example, less expensive insulating material can therefore be used and the physical volume of the post insulator can be reduced. It is necessary to ensure here that the mechanical loadings occurring can also furthermore be taken on by the post insulator.

An advantageous configuration can furthermore provide that the post insulator is designed to be substantially rotationally symmetrical with respect to an axis of rotation, and the capacitance layer is designed to be coaxial with respect to the axis of rotation.

A rotationally symmetrical design of the post insulator represents a basic shape which can be subjected to mechanical loading easily. Such basic shapes are, for example, cylinders, cones, truncated cones etc. As a result of a coaxial alignment of the capacitance layer, the mechanical basic structure of the post insulator is changed to a small extent. The capacitance layer can be formed, for example, from a plurality of capacitor plates or foils arranged coaxially with respect to one another. However, it may also be provided that a helical coil is provided in order to form the capacitance layer. The helical coil can have, for example, the shape of a hollow cylinder. A capacitance layer can be manufactured, for example, separately from the post insulator and can be pushed onto the post insulator.

Advantageously, provision may further be made for the capacitance layer to be embedded in a wall of the post insulator.

Embedding the capacitance layer in the post insulator makes it possible to match the manufacture of the post insulator and the manufacture of the capacitance layer to one another. It can thus be provided, for example, that the capacitance layer is partially or completely covered by insulating material of the post insulator. In particular in the case of a hollow construction of the post insulator, it is an option to arrange the capacitance layer completely within a wall of the post insulator.

In this case, it can advantageously be provided that the capacitance layer is arranged within an interspace, which is delimited by a hollow insulator, which overlaps an insulating body, and the insulating body.

An arrangement of the capacitance layer in an interspace makes it possible to variably provide post insulators with different capacitance layers. The insulating body and the overlapping hollow insulator in this case form a shell-like enveloping of the capacitance layer. In this case it can be provided that the insulating body is likewise a hollow insulator. As a result, the post insulator having the insulating body and the overlapping hollow insulator can as a whole be in the form of a hollow insulator. It is then possible to lay, for example, drive rods, control lines or the like through a cavity in the insulating body. As a result of the use of an insulating body and an overlapping hollow insulator, an entire system of different insulating bodies and different hollow insulators can be used, from which various post insulators can be assembled in modular fashion depending on dimension of the capacitance layer. Furthermore, provision can advantageously be made for the capacitance layer to be formed from a plurality of capacitor arrangements which are electrically connected to one another.

By skillfully electrically connecting a plurality of capacitor arrangements to one another the total capacitance of the capacitor layer can be set in a targeted manner. It is thus possible, for example, to connect a plurality of capacitor arrangements in parallel with one another in order to produce a capacitance layer with increased capacitance. Furthermore, however, it is also possible to provide series circuits comprising various capacitor arrangements and to form combinations of series circuits and parallel circuits. It can thus be provided, for example, for capacitor arrangements to be formed, for example, in the form of disk-type coils, which are inserted in the interspace described above between an insulating body and the overlapping hollow insulator and electrically connected to one another there.

Provision can advantageously be made for the post insulator to be a substantially rotationally symmetrical hollow body.

A rotationally symmetrical hollow body provides the advantage that, given a relatively low mass, a high mechanical stability can be expected. Furthermore, the space formed in the hollow body can be used in order to accommodate further add-on parts. For example, drive elements such as drive rods or control and monitoring lines etc. can thus be guided in the cavity. Furthermore, the cavity can be used for guiding arcing gases or cooling media.

A further advantageous configuration can provide that the capacitance layer forms a capacitance between an electrically conducting current path of the interrupter unit and a ground potential.

When using an electrical switching device, it can also be provided that it is in the form of a high-voltage circuit breaker. Circuit breakers, in terms of their configuration, are provided so as to be able to safely interrupt all currents occurring, i.e. operational currents, overcurrents and also short-circuit currents. In AC systems, various types of short circuit can occur. One of these types of short circuit is, for example, a short-line short circuit. In the case of a short-line short circuit, the short circuit occurs, for example, several meters, a few hundred meters or a few kilometers away from the interrupter point of the circuit breaker. During a disconnection of a short-line short-circuit current, radiofrequency compensation processes occur on the faulty line which are superimposed on the transient recovery voltage of the feeding system. The profile of the line-side transient recovery voltage is determined by two identical travelling waves, which run independently of one another in the opposite direction after the current interruption. They are reflected positively at the open switch contacts and negatively at the short-circuit point on the line.

By switching in capacitances in the form of capacitors between an overhead line and ground using a line-side switch contact, it is possible to reduce the loading of the circuit breaker which originates from the line-side transient recovery voltage. The incoming travelling waves are no longer reflected at the open switch contacts of the disconnection point but at a terminating resistor formed by the capacitances, i.e. the reflection factor is no longer 1 but <1. If a profile of the line-side transient recovery voltage which is influenced by capacitances is described by its tangent, it is possible to define a “delay time” t_{dL}, which is directly dependent on this capacitance and is proportional to it.

Until now, additional arrangements needed to be provided, for example outside or inside the housing, for such capacitors and additional physical space needed to be provided in order to accommodate such damping capacitors. As a result of the provision of the post insulators required for supporting the interrupter unit and the use of a controlling capacitance layer, it is firstly possible for the voltage distribution on the post insulator to be influenced positively, with the result that correspondingly larger power reserves in terms of the dielectric strength or a smaller physical size of the post insulator are made possible. On the other hand, the short-circuit disconnection capacity of the circuit breaker is increased whilst maintaining the physical space available within the housing, i.e. it is possible to dispense with additional capacitor arrangements outside the housing or inside the housing. As a result, the electrical switching device is not additionally increased in terms of its volume. In order to produce particularly effective coupling-in of the capacitance layer between a conducting current path of the interrupter unit and a ground potential, corresponding electrical connection points can be provided on the post insulator which make it possible to make electrical contact with the respective ends of the capacitance layer. This can take place in such a way that, for example, points which are provided on the housing for clamping in the post insulator bring about an electrical contact during fitting of the post insulator. Likewise, such a construction can also be provided on the side of the post insulator on which the interrupter unit of the electrical switching device is attached to the post insulator.

The invention will be shown schematically in a drawing using an exemplary embodiment and described in more detail below.

In the drawing:

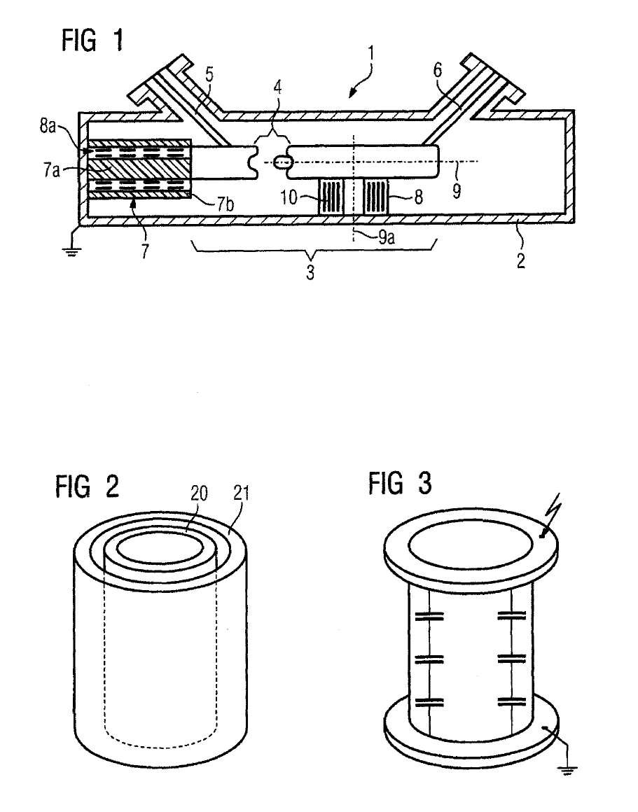

FIG. 1 shows a section through an electrical switching device,

FIG. 2 shows a first variant configuration of a post insulator, and

FIG. 3 shows a second variant configuration of a post insulator.

FIG. 1 shows an electrical switching device 1 in the form of a high-voltage circuit breaker, in section. The electrical switching device 1 has a housing 2. The housing 2 is manufactured from electrically conductive material, for example steel or aluminum. In the present case, the housing is configured in such a way that it can be filled with an electronegative gas, for example sulfur hexafluoride, nitrogen or suitable gas mixtures and this is hermetically sealed off from the surrounding environment. Such a construction makes it possible to construct compact electrical switching devices even in the high-voltage and extra-high-voltage ranges, i.e. for voltages of between 1000 V, in particular of between 30 kV and 1000 kV. Ground potential is applied to the housing 2. In the interior of the housing 2, an interrupter unit 3 of the electrical switching device 1 is arranged in electrically insulated fashion with respect to the housing 2. The interrupter unit 3 has, for example, in principle the design as is described in the laid-open specification DE 44 18 797, i.e. the interrupter unit 3 with its disconnection point 4 can be looped into a current path via electrical feed lines 5, 6. The current path can be connected in and disconnected via the disconnection point 4. In the present case, the disconnection point 4 is formed by two contact pieces which are capable of moving relative to one another.

The interrupter unit 3 is electrically insulated from the housing 2 via a gas section. In order also to keep the interrupter unit in a position in which gas sections are available which are resistant to flashovers, a first post insulator 7 and a second post insulator 8 are provided. The first post insulator 7 is attached at the end to the interrupter unit 3, which extends substantially along an axis 9. The first and second post insulators 7, 8 are each illustrated in section. In the present example, the first post insulator 7 is in the form of a solid body, and the second post insulator 8 is in the form of a hollow body.

The first post insulator 7 has an insulating body 7a, which is overlapped by a hollow insulator 7b. The insulating body 7a and the hollow insulator 7b are designed so as to be rotationally symmetrical and are aligned coaxially with respect to one another. A circumferential hollow-cylindrical interspace is formed between the insulating body 7a and the hollow insulator 7b, with a capacitance layer 8a being arranged in the interspace. It is possible for the insulating body 7a to likewise be in the form of a hollow body, with the result that a post insulator is produced which as a whole is in the form of a hollow body.

A plurality of disk-shaped coils which, spaced axially apart from one another, form the capacitance layer 8a are introduced into the hollow-cylindrical interspace between the insulating body 7a and the hollow insulator 7b. The coils can be connected to one another in a suitable form. It can be provided that the coils are each formed from a large number of coaxially arranged circumferential sleeves, or that a flat strip wound in helical fashion forms the coil. The capacitance layer 8a can be arranged in the interior of the first post insulator 7, for example within a fluid, for example sulfur hexafluoride or an insulating liquid. The capacitance layer 8a is embedded in the wall of the first post insulator 7.

The second post insulator 8 is in the form of a hollow body, which is designed to be rotationally symmetrical. The axis of rotation 9a is aligned radially with respect to the axis 9, along which the interrupter unit 3 extends. A capacitance layer 10 is formed around the axis of rotation 9a. The capacitance layer 10 is in the form of a coil. As a result of the capacitance layer, the potential distribution between the interrupter unit 3 and the housing 2 is made more uniform along the second post insulator 8. The capacitance layer 10 is formed from a coil, which has been completely surrounded with curing insulating material during the manufacturing process of the second post insulator. As a result, the capacitance layer 10 is intimately connected to the insulating material of the second post insulator 8. In the same way as the capacitance layer 10 of the second post insulator favorable influences the voltage distribution, the capacitance layer 8a arranged on the first post insulator 7 also positively influences the voltage distribution there. The post insulators 7, 8 can also be arranged in further suitable layers on the interrupter unit 10. The number of post insulators used can likewise vary. In addition to making the voltage more uniform, the capacitance layers 8a, 10 can also be used to damp an overvoltage travelling wave arriving in the event of a short-line short circuit. As a result, the short-circuit disconnection capacity of the circuit breaker is increased. In this case, the capacitance layers 8a, 10 each represent a capacitance between an electrically conducting current path (interrupter unit 3 with the feed lines 5, 6) and a ground potential (housing 2). On arrival of a travelling wave, the capacitance layers are charged and, as a result of the input of energy, the travelling wave is damped. A voltage rise which may occur over the disconnection point 4 is slowed down. As can be seen in FIG. 1, firstly the holding function and secondly the damping function are taken on by the post insulators 7, 8 which are required for supporting the interrupter unit. Since the post insulators 7, 8 hold the interrupter unit 3 in insulated fashion with respect to the grounded housing 2, a capacitance is also provided between the electrically conducting current paths of the interrupter unit 3 and a ground potential.

FIG. 2 illustrates a first variant embodiment of a post insulator. It can seen in the figure that an insulating body 20, which is designed to be hollow, is covered coaxially by a hollow insulator 21. An interspace is formed between the outer lateral surface of the insulting body 20 and the inner lateral surface of the hollow insulator 21. Capacitance layers which can have any desired configuration can be introduced into this interspace. As a result of a combination of insulating bodies 20 and hollow insulators 21 with different dimensions, interspaces of different dimensions can be formed. Then, capacitance layers of different dimensions can be introduced into these interspaces. It is thus possible, for example, to introduce a single coil, which passes through the post insulator, into the interspace. However, provision may also be made for several coils to be inserted into the interspace, for example with an axial offset.

FIG. 3 shows a second variant configuration of a post insulator. The post insulator in said figure is provided at the end with flanges. Corresponding fixing means of the housing 2 or the interrupter unit 3 can act on these flanges. In FIG. 3, the capacitance layers are indicated symbolically by two series circuits comprising in each case three capacitors, which are in turn connected electrically in parallel with one another. It can be provided that corresponding contact-making points are arranged on the flanges, via which contact-making points voltage or ground potential can in each case be applied to the capacitance layer. These contact-making points may be, for example, separate eyelets or pole shoes. However, it can also be provided that contact pads are arranged there which are electrically contact-connected to a fixing on the interrupter unit 3 or on the housing 2. The variant configurations shown in the figures can be combined with one another in terms of their nature, i.e. individual features can be swapped over. For example, various flanges can be used. Various hollow or solid insulators can be used. Various configurations of capacitance layers can be used.

1-7. (canceled)

8. An electrical switching device, comprising:
an interrupter unit;
a housing surrounding said interrupter unit;
at least one post insulator for supporting said interrupter unit electrically insulated on said housing; and
a controlling capacitance layer on said post insulator.

9. The electrical switching device according to claim 8 configured as a high-voltage circuit breaker.

10. The electrical switching device according to claim 8, wherein said post insulator is substantially rotationally symmetrical with respect to an axis of rotation, and said capacitance layer is disposed coaxially with the axis of rotation.

11. The electrical switching device according to claim 8, wherein said capacitance layer is embedded in said post insulator.

12. The electrical switching device according to claim 8, which further comprises an insulating body and a hollow insulator overlapping said insulating body forming an interspace therebetween, and wherein said capacitance layer is disposed within said interspace delimited by said hollow insulator and said insulating body.

13. The electrical switching device according to claim 8, wherein said capacitance layer is formed from a plurality of capacitor assemblies that are electrically connected to one another.

14. The electrical switching device according to claim 8, wherein said post insulator is a substantially rotationally symmetrical hollow body.

15. The electrical switching device according to claim 8, wherein said capacitance layer is configured to form a capacitance between an electrically conducting current path of said interrupter unit and a ground potential.
